(19) United States
(12) Patent Application Publication
(10) Pub. No.: US 2016/0105706 A1
(43) Pub. Date: Apr. 14, 2016

(54) METHOD AND DEVICE FOR REALIZING DISTRIBUTED REMOTE CONTROL, TELEVISION AND MOBILE TERMINAL OF THE DEVICE

(71) Applicants: Zeyin Wei, Shenzhen (CN); Lingchen Wang, Shenzhen (CN)

(72) Inventors: Zeyin Wei, Shenzhen (CN); Lingchen Wang, Shenzhen (CN)

(73) Assignee: SHENZHEN TCL NEW TECHNOLOGY CO., LTD., Shenzhen, Guangdong (CN)

(21) Appl. No.: 14/411,398

(22) PCT Filed: Jan. 16, 2014
(86) PCT No.: PCT/CN2014/070740

§ 371 Date: Dec. 26, 2014

(30) Foreign Application Priority Data
Aug. 6, 2013 (CN) 201310339800.1

(51) Int. Cl. H04N 21/4227; H04N 21/475; H04N 21/4415; H04N 21/43; H04N 21/41; H04N 21/442

(52) U.S. Cl. CPC H04N 21/4227; H04N 21/4126; H04N 21/44218; H04N 21/4415; H04N 21/4302; H04N 21/4755

(57) ABSTRACT

The present disclosure provides a method for realizing distributed remote control, including: a television sending real-time content signals to the mobile terminal; the mobile terminal receiving the real-time content signals sent from the television to obtain a real-time video program from the television, and sending a remote control request signal to the television; the television receiving the remote control request signal sent from the mobile terminal and sending a corresponding responding signal according to a user response from the mobile terminal and according to whether there is any user in front of the television, wherein the responding signal comprises a refuse signal, a free signal, and a busy signal; and the mobile terminal receiving the responding signal from the television and performing a corresponding following step according to the type of the responding signal.

### BACKGROUND

1. Technical Field

The present disclosure relates to televisions, and particularly, to a method and a device for realizing distributed remote control, and a television and a mobile terminal of the device.

2. Description of Related Art

With the development of smart televisions and other smart consumer electronic devices, a large amount of user information and data, including media files stored by users and real-time content streams of different kinds of video output devices such as a set top box, a game machine, and a blue DVD may appear in the family. The user may desire a system which can store and manage the data, such that the user may browse, edit, and share the data on a uniform operation interface. In families, televisions are typically the largest common display screen, thus, a family cloud with the television as the usage center is inevitably generated.

For real-time family content streams, the television is an access center. Various kinds of video devices are accessed to the television and are not required for movement after being arranged. The real-time content streams can be shared with other devices with screens including other televisions or mobile phones or tablets through the video streams sharing function of the family cloud of the television. However, following problems may occur in this application scene: how to remotely control the devices which produce the contents on the devices sharing the content streams, and how to realize the distributed system which can realize the synchronization of the time control in different spaces? Therefore, the existed technology needs to be improved to overcome these problems.

### SUMMARY

The main purpose of the invention is to provide a method and a device for realizing distributed remote control, and a television and a mobile terminal of the device, aiming to realize the remote control request to the device providing contents from a user sharing real-time contents of the television in different spaces, and to realize the time domain synchronization of the remote control in space.

In order to achieve the above object, a method for realizing remote control is provided. The method includes following steps:

step A, a television building a network connection with a mobile terminal;

step B, the television sending real-time content signals to the mobile terminal and monitoring a remote control request from the mobile terminal;

step C, the mobile terminal receiving the real-time content signals sent from the television to obtain a real-time video program from the television, and sending a remote control request signal to the television;

step D, the television receiving the remote control request signal sent from the mobile terminal and sending a corresponding responding signal according to a user response from the mobile terminal and according to whether there is any user in front of the television, wherein the responding signal includes a refuse signal, a free signal, and a busy signal; and

step E, the mobile terminal receiving the responding signal from the television and performing a corresponding following step according to the type of the responding signal:

step E1, if the responding signal is the refuse signal which indicates that the television refuses the remote control request directly, the mobile terminal ending the current remote control request process;

step E2, if the responding signal is the free signal which indicates that no users are watching the television, the television sending corresponding remote control code to a device providing real-time contents through an IR transmitting module of the television, ending the current remote control request process, and then entering a free remote control mode; and

step E3, if the responding signal is the busy signal which indicates that there is at least one user watching the television, the mobile terminal sending a control right applying signal to the television; if the television sending a remote control permitting signal to the mobile terminal, the mobile terminal entering the free remote control mode; if the television sending the remote control refusing signal to the mobile terminal, the mobile terminal ending the current remote control request process.

Preferably, the step D includes following steps:

step D1, the television receiving the remote control request signal sent from the mobile terminal;

step D2, the television outputting a prompt box allowing a user to choose whether to refuse the remote control request, if the user chooses to refuse the remote control request, performing step D3, if the user does not choose to refuse the remote control request, performing step D4;

step D3, the television sending the refuse signal to the mobile terminal;

step D4, the television detecting whether there is any user in front of the television watching the television, if no users are detected watching the television, performing step D5, if there is at least one user being detected watching the television, performing step D6;

step D5, the television sending the free signal to the mobile terminal; and step D6, the television sending the busy signal to the mobile terminal.

Preferably, the step of detecting whether there is any user in front of the television watching the television includes: the television starting a user detecting module, collecting a group of images in front of the television, post-processing the group of images, and performing face identification to determine whether there is any user watching the television in the group of images.

Preferably, the step of transmitting corresponding remote control code to a device providing real-time contents through an IR transmitting module of the television includes: the television obtaining an ID of the device providing real-time contents through an ID identifying module, resolving controlling original code corresponding to the remote control request signal sent by the mobile terminal from the ID of the device providing real-time contents, and sending the controlling original code to the device providing real-time contents through the IR transmitting module.

Preferably, the step E3 includes:

if the responding signal is the busy signal which indicates that there is at least one user in front of the television watching the television, the television sending an image of a user in front of the television to the video main window of the mobile terminal for displaying;

the mobile terminal sending the control right applying signal to the television and waiting for a response from the television; and

after receiving the control right applying signal, the television outputting a selection box allowing a user to choose whether to permit the remote control; if the user chooses to permit the remote control, the television sending the remote control permitting signal to the mobile terminal, and the mobile terminal entering the free remote control mode after obtaining the remote control permitting signal from the television; if the user chooses not to permit the remote control, the television sending the remote control refusing signal to the mobile terminal and the mobile terminal ending the current remote control request process after obtaining the remote control refusing signal from the television.

The present disclosure further provides a device for realizing distributed remote control, including a television and a mobile terminal building a network connection with the television;

the television is configured to: send real-time content signals to the mobile terminal and monitor a remote control request from the mobile terminal; receive a remote control request signal sent from the mobile terminal and send a corresponding responding signal to the mobile terminal according to a user response and according to whether there is any user in front of the television, wherein the responding signal includes a refuse signal, a free signal, and a busy signal; send corresponding remote control code to a device providing real-time contents after sending the free signal to the mobile terminal; and send a remote control permitting signal or a remote control refusing signal to the mobile terminal after receiving a control right applying signal from the mobile terminal;

the mobile terminal is configured to: receive the real-time content signals sent from the television to obtain a real-time video program and send the remote control request signal to the television; end the current remote control request process after receiving the refuse signal; end the current remote control request process after receiving the free signal and entering a free remote control mode; send the control right applying signal to the television after receiving the free signal; enter the free remote control mode after receiving the remote control permitting signal; and end the current remote control request process after receiving the remote control refusing signal.

Preferably, the television is further configured to: output a prompt box allowing a user to choose whether to refuse the remote control request after receiving the remote control request signal from the mobile terminal; send the refuse signal to the mobile terminal when the user chooses to refuse the remote control request; detect whether there is at least one user in front of the television when the user does not choose to refuse the remote control request, send the free signal to the mobile terminal when no users are detected watching the television; send the busy signal to the mobile terminal and send an image of a user in front of the television to a video main window of the mobile terminal for displaying when there is at least one user being detected watching the television.

Preferably, the television detects whether there is any user in the group of images watching the television by starting an user detecting module, collecting a group of images in front of the television, post-processing the group of images, and performing face identification to determine whether there is any user watching the television in the group of images.

Preferably, the television obtains an ID of the device providing real-time contents through the ID identifying module, resolves controlling original code corresponding to the remote control request signal sent by the mobile terminal from the ID of the device providing real-time contents, and sends the controlling original code to the device providing real-time contents through an IR transmitting module.

Preferably, the television is further configured to send an image of a user in front of the television to the video main window of the mobile terminal for displaying.

Preferably, the television is further configured to output a selection box allowing a user to choose whether to permit the remote control after receiving a control right applying signal from the mobile terminal, and send a remote control permitting signal or a remote control refusing signal to the mobile terminal after receiving a responding signal from the selection box according to selection of the user.

The present disclosure further provides a television adapted in the device for realizing distributed remote control of claim 6, wherein the television includes a network connection module, a monitoring and processing module, an IR transmitting module, and a coding module;

the network connection module is configured to build a network connection with a mobile terminal for exchanging data with the mobile terminal, communicate with the monitoring and processing module, and receive and send a command from the monitoring and processing module;

the monitoring and processing module is configured to monitor the remote control request from the mobile terminal; after receiving the remote control request signal from the mobile terminal, generate the corresponding responding signal according to a user response from the television and according to whether there is any user in front of the television, and further send the responding signal to the mobile terminal through the network connection module, wherein the responding signal includes the refuse signal, the free signal, and the busy signal; build a free remote control connection with the mobile terminal when no users are watching the television and when the user allows the mobile terminal to control the television;

the IR transmitting module is configured to send an infrared code command to the device providing real-time contents; and

the coding module is configured to coding video streams and audio streams input by the device providing real-time contents to compressed binary data streams to form real-time content signals, and provide the real-time content signals to the mobile terminal through the network connection module.

Preferably, the monitoring and processing module is further configured to output a prompt box allowing a user to choose whether to refuse the remote control request after receiving the remote control request signal sent from the mobile terminal, and to output a selection box allowing a user to choose whether to permit the remote control after receiving the control right applying signal.

Preferably, the television further includes a user detecting module; the detecting module is configured to collect a group of images in front of the television when receiving the command from the monitoring and processing module, determine whether there is any user watching the television in the group of images according to the group of images, and output an analyzing result to the monitoring and processing module.

Preferably, the television further includes an ID identifying module; the ID identifying module is configured to obtain an ID of the device providing real-time contents, resolve the controlling original code corresponding to the remote control request signal sent by the mobile terminal from the ID of the device providing real-time contents, and send the controlling original code to the device providing real-time contents through the IR transmitting module.

Preferably, the television further includes an ID identifying module, the ID identifying module is configured to obtain an ID of the device providing real-time contents, resolve controlling original code corresponding to the remote control request signal sent by the mobile terminal from the ID of the device providing real-time contents, and send the controlling original code to the device providing real-time contents through the IR transmitting module.

The present disclosure further provides a mobile terminal adapted in the device for realizing distributed remote control of claim 6, wherein the mobile terminal includes a network connection module, a decoding module, a displaying module, and a remote control request module;

the network connection module is configured to build a network connection with a television to exchange data with the television, and communicate with the remote control request module to receive a command from the remote control request module and to send a command to the remote control request module;

the decoding module is configured to decode the obtained video streams and audio streams from the television, and send the decoded video streams and audio streams to the displaying module for displaying;

the displaying module is configured to play or display the video streams and audio streams decoded by the decoding module;

the remote control request module is configured to send the remote control request signal to the television after obtaining the real-time video program of the television; end the current remote control request process after receiving the refuse signal from the television; end the current remote control request process and build a free remote control connection with the television after receiving the free signal; send the control right applying signal to the television after receiving the busy signal; build the free remote control connection with the television after receiving the remote control permitting signal; and end the current remote control request process after receiving the remote control refusing signal.

In the method and device for realizing distributed remote control and the television and mobile terminal of the present disclosure, corresponding responding signal is sent to the mobile terminal according to the user response and according to whether there is any user in front of the television, which realizes the time domain synchronization of the remote control in space and thus realizes the remote control to the device providing real-time contents from the user sharing the real-time contents of the television in different spaces when the user.

### DESCRIPTION OF THE DRAWINGS

FIG. 1 is a schematic view of a device for realizing distributed remote control in accordance with an embodiment of the present disclosure;

FIG. 2 is a flow chart of a method for realizing distributed remote control in accordance with an embodiment of the present disclosure; and

FIG. 3 is a detailed flow chart of a step D of the method of FIG. 2.

The realization of the object, features, and advantages of the present disclosure are given in further detail in combination with the embodiments with reference to the accompanying drawings.

### DETAILED DESCRIPTION

It should be understood that the embodiments described herein are only used to explain the present disclosure rather than to limit the present disclosure.

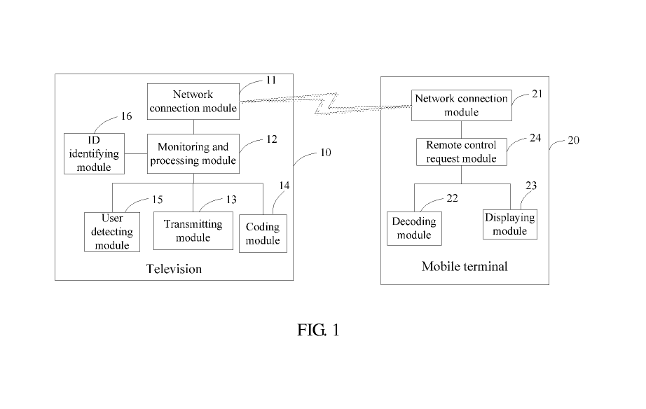

As shown in FIGS. 1 to 3, a device for realizing distributed remote control in accordance with an embodiment includes a television 10 and a mobile terminal 20 which builds a network connection with the television 10.

The television is configured to: send real-time content signals to the mobile terminal 20 and monitor a remote control request from the mobile terminal 20; receive the remote control request sent from the mobile terminal 20 and send a corresponding responding signal to the mobile terminal 20 according to a user response and according to whether there is any user in front of the television 10, wherein the responding signal includes a refuse signal (S_REFUSE), a free signal (S_FREE), and a busy signal (S_BUSY); send corresponding remote control code to a device providing real-time contents after sending the free signal to the mobile terminal 20; and send a remote control permitting signal or a remote control refusing signal to the mobile terminal 20 after receiving a control right applying signal sent by the mobile terminal 20.

The television 10 is further configured to: output a prompt box allowing the user to choose whether to refuse the remote control request after receiving the remote control request signal from the mobile terminal 20. When the user chooses to refuse the remote control request, the television 10 is configured to send the refuse signal (S_REFUSE) to the mobile terminal 20. When the user does not respond to the outputted box, the television 10 is configured to detect whether there is at least one user in front of the television 10 watching the television 10; when no users are detected watching the television 10, the television 10 sends the free signal (S_FREE) to the mobile terminal 20; when there is at least one user being detected watching the television 10, the television 10 sends the busy signal (S_BUSY) to the mobile terminal 20 and sends an image of the user in front of the television 10 to a video main window of the mobile terminal 20 for displaying. In order to facilitate the operation of the mobile terminal 20, suspended display is preferable.

The mobile terminal 20 is configured to: obtain a real-time video program and send the remote control request signal to the television 10; end the current remote control request process after receiving the refuse signal; end the current remote control request process after receiving the free signal and enter a free remote control mode; send the control right applying signal to the television 10 after receiving the busy signal; enter the free remote control mode after receiving the remote control permitting signal; and end the current remote control request process after receiving the remote control refusing signal.

The free remote control mode means that, the mobile terminal 20 is capable of, after the mobile terminal 20 gets the permission from the television 10, sending the remote control signal to the television 10 freely without confirmation from the user in front of the television 10. The television 10 transmits the remote control signal through an infrared (IR) transmitting module thereof to a device providing real-time contents such as a set top box, thereby remotely controlling the device providing real-time contents.

The television 10 includes a network connection module 11, a monitoring and processing module 12, an IR (infrared) transmitting module 13, a coding module 14, a user detecting module 15, and an ID (identification) identifying module 16.

The network connection module 11 is configured to build a network connection with the mobile terminal 20 to exchange data with the mobile terminal 20, and communicate with the monitoring and processing module 12 such that the network connection module 11 can receive a command from the monitoring and processing module 12 and can send a command to the monitoring and processing module 12. The network connection module 11 can be connected with the mobile terminal 20 through Internet, Mobile Internet such as 3G or 4G, Bluetooth, or Wi-Fi.

The monitoring and processing module 12 is configured to monitor the remote control request from the mobile terminal 20; generate the corresponding responding signal according to the user response from the television 10 and according to whether there is any user in front of the television after receiving the remote control request signal from the mobile terminal 20; send the responding signal to the mobile terminal 20 through the network connection module 11, wherein the responding signal includes the refuse signal, the free signal, and the busy signal; and build the free remote control connection with the mobile terminal 20 when no users are watching the television 10 and when the user allows the mobile terminal 20 to control the television 10.

The IR transmitting module 13 includes an IR emitting tube for sending IR commands to the device providing real-time contents such as a set top box.

The coding module 14 includes a video coder (such as H264, MJPEG, MPEG4) and an audio coder (such as mp3 and AAC) configured to code video streams and audio streams input by the device providing real-time contents to compressed binary data streams to form real-time content signals, and provide the real-time content signals to the mobile terminal 20 through the network connection module 11.

The user detecting module 15 is configured to collect a group of images in front of the television 10 when receiving the command from the monitoring and processing module 12, determine whether there is any user watching the television in the group of images according to the group of images, and output an analyzing result to the monitoring and processing module 12.

The user detecting module 15 includes a camera, a collecting unit, an image post-processing unit, and a face identifying unit. The collecting unit is configured to control the camera to collect the group of images in front of the television 10. The image post-processing unit is configured to post-process the collected images. The face identifying unit is configured to perform face identification to the post-processed images to determine whether there is any user in the images watching the television, and output the analyzing result to the monitoring and processing module 12 in a Boolean value (TRUSE/FALSE).

The ID identifying module 16 includes a HDMI CEC communicating device and an ID database. The ID identifying module 16 is configured to obtain an ID of the device providing real-time contents through the HDMI CEC communicating device such as the ID of a DVD, a set top box, and a game machine. The ID identifying module 16 is further configured to resolve the controlling original code corresponding to the remote control request signal sent by the mobile terminal 20 from the ID of the device providing real-time contents, for example, resolve the controlling original code CH+0Xff001e1e from the remote control request signal 0X0010 sent by the mobile terminal 20, and send the controlling original code to the device providing real-time contents through the IR transmitting module 13.

The monitoring and processing module 12 is further configured to, after receiving the remote control request signal sent from the mobile terminal 20, output the prompt box allowing the user to choose whether to refuse the remote control request; and configured to output a selection box allowing the user to choose whether to permit the remote control request after receiving the control right applying signal.

The mobile terminal 20 includes a network connection module 21, a decoding module 22, a displaying module 23, and a remote control request module 24.

The mobile terminal 20 can be any terminal with network connecting function, displaying function and remote control command inputting function, such as a mobile phone or a tablet computer.

The network connection module 21 is configured to build a network connection with the television 10 to exchange data with the television 10, communicate with the remote control request module 24 to receive a command from the remote control request module 24 and to send a command to the remote control request module 24. The network connection module 21 can be connected with the television through Internet, Mobile Internet such as 3G or 4G, Bluetooth, or Wi-Fi.

The decoding module 22 includes a video decoder and an audio decoder for decoding the obtained video streams and audio streams from the television 10, and sending the decoded video streams and audio streams to the displaying module 23 for displaying.

The displaying module 23 is configured to play or display the video streams and audio streams decoded by the decoding module 22.

The remote control request module 24 is configured to send the remote control request signal to the television 10 after obtaining the real-time video program of the television 10; end the current remote control request process after receiving the refuse signal from the television 10; end the current remote control request process and build the free remote control connection with the television after receiving the free signal; send the control right applying signal to the television 10 after receiving the busy signal; build the free remote control connection with the television after receiving the remote control permitting signal; and end the current remote control request process after receiving the remote control refusing signal.

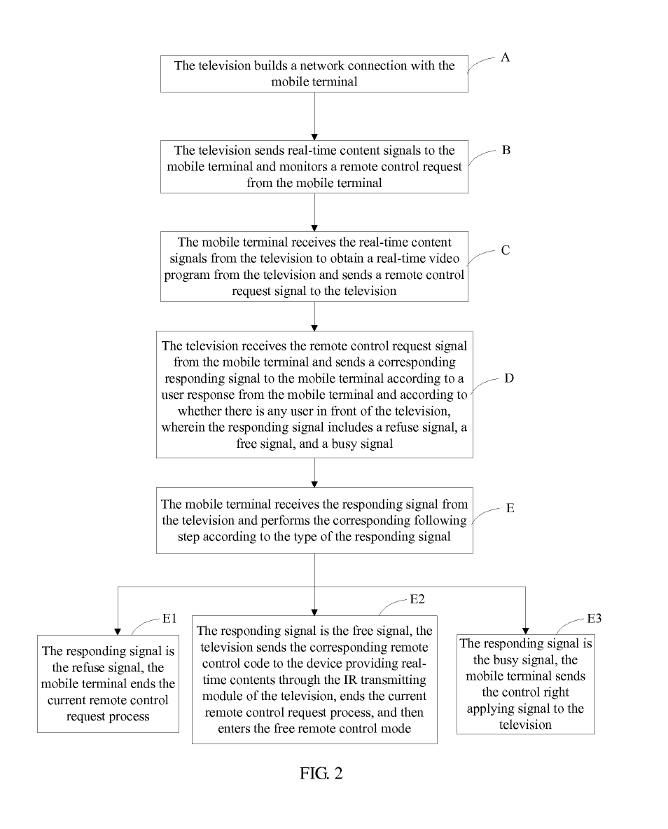

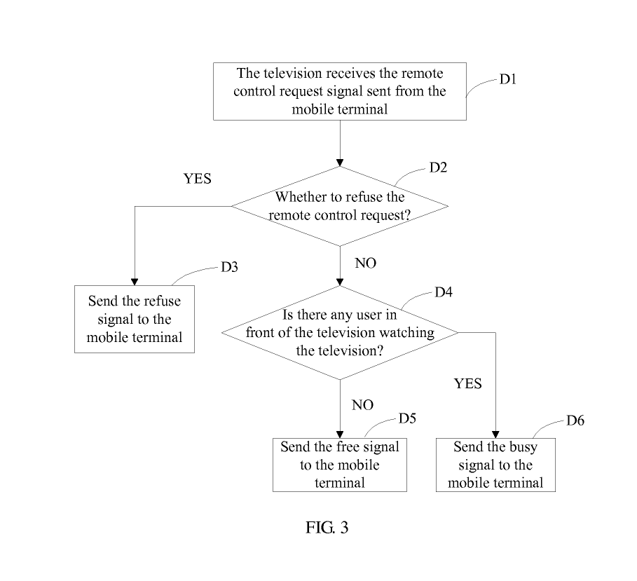

Referring to FIGS. 2 and 3, in combination with FIG. 1, the method for realizing distributed remote control provided in an embodiment includes steps as follows.

Step A, the television 10 builds a network connection with the mobile terminal 20.

The television 10 can be connected with the mobile terminal 20 through Internet, Mobile Internet such as 3G or 4G, Bluetooth, or Wi-Fi, thus, data can be exchanged between the television 10 and the mobile terminal 20.

Step B, the television sends real-time content signals to the mobile terminal 20 and monitors a remote control request from the mobile terminal 20.

The television 10 sends the real-time content signals to the mobile terminal 20 by starting a video information source transmitting program; and the television 10 monitors the remote control request from the mobile terminal 20 by starting a remote control request monitoring program.

Step C, the mobile terminal 20 receives the real-time content signals from the television 10 to obtain a real-time video program from the television 10 and sends a remote control request signal to the television 10.

The mobile terminal 20 receives the real-time content signals from the television 10 by starting a real-time content starting program, sends the remote control request signal to the television 10 by starting a remote control input module, and then waits for the response from the television 10. For example, the mobile terminal 20 sends the remote control request signal with the remote control code 0X0010 which represents that the device providing the real-time contents under the current information source needs to perform the “CH+” operation.

Step D, the television 10 receives the remote control request signal from the mobile terminal 20 and sends a corresponding responding signal according to a user response from the mobile terminal 10 and according to whether there is any user in front of the television 10. The responding signal includes a refuse signal (S_REFUSE), a free signal (S_FREE), and a busy signal (S_BUSY).

Referring to FIG. 3, the step D includes the following steps:

step D1, the television 10 receives the remote control request signal sent from the mobile terminal 20;

step D2, the television 10 outputs a prompt box allowing the user to choose whether to refuse the remote control request, if the user chooses to refuse the remote control request, performing step D3, if the user does not choose to refuse the remote control request, performing step D4;

step D3, the television 10 sends the refuse signal (S_REFUSE) to the mobile terminal 20;

step D4, the television 10 detects whether there is any user in front of the television watching the television, if no users are detected watching the television 10, performing step D5, if there is at least one user being detected watching the television, performing step D6;

step D5, the television 10 sends the free signal (S_FREE) to the mobile terminal 20; and

step D6, the television 10 sends the busy signal (S_BUSY) to the mobile terminal 20.

The television 10 detects whether there is any user in front of the television watching the television by image recognization, and the step that the television 10 detects whether there is any user in front of the television watching the television 10 includes: the television 10 starts the user detecting module 15, collects a group of images in front of the television 10, processes the group of images, and performs face identification to determine whether there is any user in the group of images watching the television.

If the user does not choose to refuse the remote control request, a timer is started; if no operations from the user are received after a predetermined period, determining that the user does not choose to refuse the remote control request.

Step E, the mobile terminal 20 receives the responding signal from the television 10 and performs the corresponding following step according to the type of the responding signal.

Step E1, if the responding signal is the refuse signal (S_REFUSE) which indicates that the television 10 refuses the remote control request directly, the mobile terminal 20 ends the current remote control request process.

Step E2, if the responding signal is the free signal (S_FREE) which indicates that no users are watching the television, the television 10 sends the corresponding remote control code to the device providing real-time contents through the IR transmitting module 13 of the television 10, ends the current remote control request process, and then enters the free remote control mode.

The step that the television 10 sends the corresponding remote control code to the device providing real-time contents through the IR transmitting module 13 includes: the television 10 obtains an ID of the device providing real-time contents through the ID identifying module 16, resolves the controlling original code corresponding to the remote control request signal sent by the mobile terminal from the ID of the device providing real-time contents, and sends the controlling original code to the device providing real-time contents through the IR transmitting module 13. For example, the television 10 resolves the controlling original code CH+0Xff001e1e sent by the mobile terminal 20 from the remote control request signal 0X0010, and sends the controlling original code to the device providing real-time contents through the IR transmitting module 13.

Step E3, if the responding signal is the busy signal (S_BUSY) which indicates that there is at least one user in front of the television 10, the mobile terminal 20 sends the control right applying signal to the television 10; if the television 10 sends the remote control permitting signal to the mobile terminal 20, the mobile terminal 20 enters the free remote control mode; if the television 10 sends the remote control refusing signal to the mobile terminal 20, the mobile terminal 20 ends the current remote control request process.

The step E3 is detailed as follows:

if the responding signal is the busy signal (S_BUSY) which indicates that there is at least one user in front of the television 10 watching the television, the television 10 sends the image of the user in front of the television 10 to the video main window of the mobile terminal 20 for displaying;

the mobile terminal 20 sends the control right applying signal to the television 10 and waits for the response from the television 10; and after receiving the control right applying signal, the television outputs a selection box allowing the user to choose whether to permit the remote control; if the user chooses to permit the remote control, the television 10 sends the remote control permitting signal to the mobile terminal 20, and the mobile terminal 20 enters the free remote control mode after obtaining the remote control permitting signal from the television 10; if the user chooses not to permit the remote control, the television 10 sends the remote control refusing signal to the mobile terminal 20, and the mobile terminal 20 ends the current remote control request process after obtaining the remote control refusing signal from the television 10.

In the step that the mobile terminal 20 sends the control right applying signal to the television, the control right applying signal can be sent to the television 10 by clicking the control button of the video main window of the mobile terminal 20.

In the method and device for realizing distributed remote control of the present disclosure, corresponding responding signal is sent to the mobile terminal 20 according to the user response and according to whether there is any user in front of the television, which realizes the time domain synchronization of the remote control in space and thus realizes the remote control to the device providing real-time contents from the user sharing the real-time contents of the television in different spaces.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A method for realizing remote control, comprising following steps:
step A, a television building a network connection with a mobile terminal;
step B, the television sending real-time content signals to the mobile terminal and monitoring a remote control request from the mobile terminal;
step C, the mobile terminal receiving the real-time content signals sent from the television to obtain a real-time video program from the television, and sending a remote control request signal to the television;
step D, the television receiving the remote control request signal sent from the mobile terminal and sending a corresponding responding signal according to a user response from the mobile terminal and according to whether there is any user in front of the television, wherein the responding signal comprises a refuse signal, a free signal, and a busy signal; and
step E, the mobile terminal receiving the responding signal from the television and performing a corresponding following step according to a type of the responding signal:
step E1, if the responding signal is the refuse signal which indicates that the television refuses the remote control request directly, the mobile terminal ending the current remote control request process;
step E2, if the responding signal is the free signal which indicates that no users are watching the television, the television sending corresponding remote control code to a device providing real-time contents through an IR transmitting module of the television, ending the current remote control request process, and then entering a free remote control mode; and
step E3, if the responding signal is the busy signal which indicates that there is at least one user watching the television, the mobile terminal sending a control right applying signal to the television; if the television sending a remote control permitting signal to the mobile terminal, the mobile terminal entering the free remote control mode; if the television sending the remote control refusing signal to the mobile terminal, the mobile terminal ending the current remote control request process.

2. The method of claim 1, wherein the step D comprises following steps:
step D1, the television receiving the remote control request signal sent from the mobile terminal;
step D2, the television outputting a prompt box allowing a user to choose whether to refuse the remote control request, if the user chooses to refuse the remote control request, performing step D3, if the user does not choose to refuse the remote control request, performing step D4;
step D3, the television sending the refuse signal to the mobile terminal;
step D4, the television detecting whether there is any user in front of the television watching the television, if no users are detected watching the television, performing step D5, if there is at least one user being detected watching the television, performing step D6;
step D5, the television sending the free signal to the mobile terminal; and
step D6, the television sending the busy signal to the mobile terminal.

3. The method of claim 2, wherein the step of detecting whether there is any user in front of the television watching the television comprises: the television starting a user detecting module, collecting a group of images in front of the television, post-processing the group of images, and performing face identification to determine whether there is any user watching the television in the group of images.

4. The method of claim 1, wherein the step of transmitting corresponding remote control code to a device providing real-time contents through an IR transmitting module of the television comprises: the television obtaining an ID of the device providing real-time contents through an ID identifying module, resolving controlling original code corresponding to the remote control request signal sent by the mobile terminal from the ID of the device providing real-time contents, and sending the controlling original code to the device providing real-time contents through the IR transmitting module.

5. The method of claim 1, wherein the step E3 comprises:
if the responding signal is the busy signal which indicates that there is at least one user in front of the television watching the television, the television sending an image of a user in front of the television to the video main window of the mobile terminal for displaying;
the mobile terminal sending the control right applying signal to the television and waiting for a response from the television; and
after receiving the control right applying signal, the television outputting a selection box allowing a user to choose whether to permit the remote control; if the user chooses to permit the remote control, the television sending the remote control permitting signal to the mobile terminal, and the mobile terminal entering the free remote control mode after obtaining the remote control permitting signal from the television; if the user chooses not to permit the remote control, the television sending the remote control refusing signal to the mobile terminal and the mobile terminal ending the current remote control request process after obtaining the remote control refusing signal from the television.

6. A device for realizing distributed remote control, comprising a television and a mobile terminal building a network connection with the television;
the television is configured to: send real-time content signals to the mobile terminal and monitor a remote control request from the mobile terminal; receive a remote control request signal sent from the mobile terminal and send a responding signal to the mobile terminal according to a user response and according to whether there is any user in front of the television, wherein the responding signal comprises a refuse signal, a free signal, and a busy signal; send corresponding remote control code to a device providing real-time contents after sending the free signal to the mobile terminal; and send a remote control permitting signal or a remote control refusing signal to the mobile terminal after receiving a control right applying signal from the mobile terminal;
the mobile terminal is configured to: receive the real-time content signals sent from the television to obtain a real-time video program and send the remote control request signal to the television; end the current remote control request process after receiving the refuse signal; end the current remote control request process after receiving the free signal and entering a free remote control mode; send the control right applying signal to the television after receiving the free signal; enter the free remote control mode after receiving the remote control permitting signal; and end the current remote control request process after receiving the remote control refusing signal.

7. The device of claim 6, wherein the television is further configured to: output a prompt box allowing a user to choose whether to refuse the remote control request after receiving the remote control request signal from the mobile terminal; send the refuse signal to the mobile terminal when the user chooses to refuse the remote control request; detect whether there is at least one user in front of the television when the user does not choose to refuse the remote control request, send the free signal to the mobile terminal when no users are detected watching the television; send the busy signal to the mobile terminal and send an image of a user in front of the television to a video main window of the mobile terminal for displaying when there is at least one user being detected watching the television.

8. The device of claim 7, wherein the television detects whether there is any user in the group of images watching the television by starting an user detecting module, collecting a group of images in front of the television, post-processing the group of images, and performing face identification to determine whether there is any user watching the television in the group of images.

9. The device of claim 6, wherein the television obtains an ID of the device providing real-time contents through the ID identifying module, resolves controlling original code corresponding to the remote control request signal sent by the mobile terminal from the ID of the device providing real-time contents, and sends the controlling original code to the device providing real-time contents through an IR transmitting module.

10. The device of claim 6, wherein the television is further configured to send an image of a user in front of the television to the video main window of the mobile terminal for displaying.

11. The device of claim 6, wherein the television is further configured to output a selection box allowing a user to choose whether to permit the remote control after receiving a control right applying signal from the mobile terminal, and send a remote control permitting signal or a remote control refusing signal to the mobile terminal after receiving a responding signal from the selection box according to selection of the user.

12. A television adapted in the device for realizing distributed remote control of claim 6, wherein the television comprises a network connection module, a monitoring and processing module, an IR transmitting module, and a coding module;
the network connection module is configured to build a network connection with a mobile terminal for exchanging data with the mobile terminal, communicate with the monitoring and processing module, and receive and send a command from the monitoring and processing module;
the monitoring and processing module is configured to monitor the remote control request from the mobile terminal; after receiving the remote control request signal from the mobile terminal, generate the corresponding responding signal according to a user response from the television and according to whether there is any user in front of the television, and further send the responding signal to the mobile terminal through the network connection module, wherein the responding signal comprises the refuse signal, the free signal, and the busy signal; build a free remote control connection with the mobile terminal when no users are watching the television and when the user allows the mobile terminal to control the television;
the IR transmitting module is configured to send an infrared code command to the device providing real-time contents; and
the coding module is configured to coding video streams and audio streams input by the device providing real-time contents to compressed binary data streams to form real-time content signals, and provide the real-time content signals to the mobile terminal through the network connection module.

13. The television of claim 12, wherein the monitoring and processing module is further configured to output a prompt box allowing a user to choose whether to refuse the remote control request after receiving the remote control request signal sent from the mobile terminal, and to output a selection box allowing a user to choose whether to permit the remote control after receiving the control right applying signal.

14. The television of claim 12, wherein the television further comprises a user detecting module; the detecting module is configured to collect a group of images in front of the television when receiving the command from the monitoring and processing module, determine whether there is any user watching the television in the group of images according to the group of images, and output an analyzing result to the monitoring and processing module.

15. The television of claim 14, wherein the television further comprises an ID identifying module; the ID identifying module is configured to obtain an ID of the device providing real-time contents, resolve the controlling original code corresponding to the remote control request signal sent by the mobile terminal from the ID of the device providing real-time contents, and send the controlling original code to the device providing real-time contents through the IR transmitting module.

16. The television of claim 12, wherein the television further comprises an ID identifying module, the ID identifying module is configured to obtain an ID of the device providing real-time contents, resolve controlling original code corresponding to the remote control request signal sent by the mobile terminal from the ID of the device providing real-time contents, and send the controlling original code to the device providing real-time contents through the IR transmitting module.

17. A mobile terminal adapted in the device for realizing distributed remote control of claim 6, wherein the mobile terminal comprises a network connection module, a decoding module, a displaying module, and a remote control request module;
the network connection module is configured to build a network connection with a television to exchange data with the television, and communicate with the remote control request module to receive a command from the remote control request module and to send a command to the remote control request module;
the decoding module is configured to decode the obtained video streams and audio streams from the television, and send the decoded video streams and audio streams to the displaying module for displaying;
the displaying module is configured to play or display the video streams and audio streams decoded by the decoding module;
the remote control request module is configured to send the remote control request signal to the television after obtaining the real-time video program of the television; end the current remote control request process after receiving the refuse signal from the television; end the current remote control request process and build a free remote control connection with the television after receiving the free signal; send the control right applying signal to the television after receiving the busy signal; build the free remote control connection with the television after receiving the remote control permitting signal; and end the current remote control request process after receiving the remote control refusing signal.
